(19) United States
(12) Patent Application Publication
(10) Pub. No.: US 2025/0206631 A1
(43) Pub. Date: Jun. 26, 2025

(54) MANUFACTURING APPARATUS FOR CALCIUM CARBONATE AND MANUFACTURING METHOD FOR CALCIUM CARBONATE

(71) Applicant: NORITAKE CO., LIMITED, Nagoya-shi, Aichi (JP)

(72) Inventors: Yasushi Yoshino, Nagoya-shi, Aichi (JP); Takayuki Ohashi, Nagoya-shi, Aichi (JP)

(21) Appl. No.: 18/851,597

(22) PCT Filed: Mar. 28, 2023
(86) PCT No.: PCT/JP2023/012530

§ 371 Date: Sep. 26, 2024

(30) Foreign Application Priority Data
Mar. 31, 2022 (JP) 2022-059717

(51) Int. Cl. C01F 11/18; B01F 23/237; B01F 25/314; B01F 25/50

(52) U.S. Cl. CPC C01F 11/181; B01F 23/23762; B01F 25/31421; B01F 25/50

(57) ABSTRACT

A manufacturing apparatus for calcium carbonate can fix carbon dioxide as calcium carbonate safely and without releasing carbon dioxide to the air. A manufacturing apparatus for calcium carbonate includes a reaction tank, a slurry supplying means, a fine bubble generation device, and a circulation line that includes a space where a slurry can flow and that is formed through the reaction tank and the fine bubble generation device. The reaction tank has the airtightness to not release carbon dioxide. The slurry supplying means supplies the slurry containing calcium hydroxide into the reaction tank. The fine bubble generation device includes a fine bubble generation tube with a tubular shape that is formed of a porous body. Carbon dioxide is blown as fine bubbles into the slurry flowing in the fine bubble generation tube by supplying a carbon dioxide gas into the fine bubble generation device from the outside.

### TECHNICAL FIELD

The present invention relates to a manufacturing apparatus for calcium carbonate and a manufacturing method for calcium carbonate. More specifically, the present invention relates to an apparatus and a method for manufacturing calcium carbonate by fixing carbon dioxide as calcium carbonate. This application claims the benefit of priority to Japanese Patent Application No. 2022-059717 filed on Mar. 31, 2022. The entire contents of this application are incorporated herein by reference.

### BACKGROUND ART

Carbon dioxide (CO₂) becomes greenhouse gas that has a large influence on environmental issues such as global warming, so that a drastic reduction of emission has been demanded. In view of this, a technique of collecting selectively carbon dioxide emitted from thermal electric power plants, factories, and the like and fixing carbon dioxide has been advanced.

Examples of the known technique related to collection and fixation of carbon dioxide include a method of fixing carbon dioxide as a carbonate (such as calcium carbonate or magnesium carbonate) through a chemical reaction. Patent Literatures 1 and 2 describe methods of manufacturing calcium carbonate. In addition, there are various techniques suggested regarding the manufacturing method for calcium carbonate. Patent Literature 3 discloses a method of precipitating calcium carbonate and/or magnesium carbonate in the presence of ultrafine bubbles including a carbonate gas.

### CITATION LIST

### Patent Literature

Patent Literature 1: Japanese Patent No. 3995761
Patent Literature 2: Japanese Patent No. 4961074
Patent Literature 3: Japanese Patent No. 6742867

### SUMMARY OF INVENTION

### Technical Problem

Incidentally, from the viewpoint of fixing carbon dioxide more certainly, it is preferable that a container (for example, reaction tank) used in a reaction between carbon dioxide and a slurry containing calcium hydroxide, or the like have the airtightness of such a degree that carbon dioxide is not released. According to the present inventors' earnest examinations, it has been found out that, in a case of blowing a carbonate gas in accordance with the techniques disclosed in Patent Literatures 1 to 3, carbon dioxide in an amount far more than the amount capable of reacting with the slurry or the like is blown; thus, in the container with the aforementioned airtightness, the pressure in the container becomes too high (for example, more than 0.3 MPa). If the pressure in the container becomes too high, there is a problem in terms of safety; for example, the container is damaged. That is to say, a manufacturing technique for calcium carbonate that can fix carbon dioxide as calcium carbonate without releasing carbon dioxide to the outside and securing the safety has been demanded.

The present invention has been made in view of the above circumstances, and an object is to provide a manufacturing apparatus for calcium carbonate that can fix carbon dioxide as calcium carbonate safely without releasing carbon dioxide to the air. Another object is to provide a manufacturing method for calcium carbonate that can fix carbon dioxide as calcium carbonate without releasing carbon dioxide.

### Solution to Problem

In order to achieve the object described above, a manufacturing apparatus for calcium carbonate disclosed herein is provided. The manufacturing apparatus for calcium carbonate disclosed herein includes a reaction tank, a slurry supplying means, a fine bubble generation device, and a circulation line that includes a space in which flow is possible and that is formed through the reaction tank and the fine bubble generation device. The reaction tank has airtightness not to release carbon dioxide. The slurry supplying means supplies a slurry containing calcium hydroxide into the reaction tank. The fine bubble generation device includes a fine bubble generation tube with a tubular shape that is formed of a porous body, and the fine bubble generation tube and the circulation line are connected to each other. The fine bubble generation device supplies a carbon dioxide gas from outside, thereby blowing carbon dioxide as fine bubbles into the slurry flowing in the fine bubble generation tube.

With such a structure, even when a container configured not to release carbon dioxide is used, carbon dioxide can be blown into a slurry containing calcium hydroxide without excessively increasing the pressure in the container (for example, with the maximum pressure in the container less than or equal to 0.3 MPa). Thus, the manufacturing apparatus for calcium carbonate that can fix carbon dioxide as calcium carbonate safely without releasing carbon dioxide to the air can be achieved.

In a preferred aspect of the manufacturing apparatus for calcium carbonate disclosed herein, the circulation line is configured to circulate the slurry from an upper part to a bottom part of the reaction tank. The circulation line of the aforementioned manufacturing apparatus may include an inline mixer on a downstream side relative to the fine bubble generation device. In another preferred aspect, the reaction tank of the manufacturing apparatus disclosed herein may include a stirring machine that can stir the slurry.

With such a structure, the manufacturing apparatus for calcium carbonate that can fix carbon dioxide as calcium carbonate more efficiently without releasing carbon dioxide to the outside can be achieved.

In a preferred aspect of the manufacturing apparatus for calcium carbonate disclosed herein, a second circulation line that includes a space in which the supplied carbon dioxide can flow and that is formed through the reaction tank and a carbon dioxide supplying means is provided. The second circulation line may be configured to circulate carbon dioxide from the upper part to the bottom part of the reaction tank.

With such a structure, the blown carbon dioxide can be fixed as calcium carbonate more efficiently.

In another aspect of the art disclosed herein, a manufacturing method for calcium carbonate is provided. The manufacturing method for calcium carbonate disclosed herein includes: a step A of preparing a slurry containing calcium hydroxide; a step B of supplying the slurry into a reaction tank with airtightness not to release carbon dioxide to an air; a step C of circulating the slurry supplied into the reaction tank using a circulation line formed through the reaction tank and a fine bubble generation device; and a step D of blowing carbon dioxide as fine bubbles into the circulating slurry using the fine bubble generation device. The fine bubble generation device used in the step D includes a fine bubble generation tube with a tubular shape that is formed of a porous body, and the fine bubble generation tube and the circulation line are connected to each other. Here, in the step D, when a flow rate of the slurry circulating in the circulation line is a flow rate X (ml/min) and a supply rate of a carbon dioxide gas to the fine bubble generation device is a supply rate Y (ml/min), the carbon dioxide gas is supplied from outside to the fine bubble generation device so that a ratio (Y/X) of the supply rate Y of the carbon dioxide gas to the flow rate X of the slurry becomes 1 or less and the carbon dioxide is blown as the fine bubbles into the slurry flowing in the fine bubble generation tube.

With such a structure, the flow rate X of the slurry and the supply rate Y of the carbon dioxide gas are adjusted suitably and the excessive supply of carbon dioxide into the container is prevented; thus, the excessive increase in pressure in the container can be suppressed. Accordingly, a method of fixing carbon dioxide as calcium carbonate without releasing carbon dioxide can be achieved.

In a preferred aspect of the manufacturing method disclosed herein, the ratio (Y/X) of the supply rate Y of the carbon dioxide to the flow rate X of the slurry is 0.16 or more and 1 or less. In another preferred aspect of the manufacturing method disclosed herein, a concentration of the calcium hydroxide in the slurry containing the calcium hydroxide is 0.1 mol/L or more and 4 mol/L or less.

With such a structure, a suitable amount of carbon dioxide can be blown into the slurry containing calcium hydroxide as the fine bubbles.

In a preferred aspect of the manufacturing method disclosed herein, in the step C, the slurry supplied to the reaction tank circulates from an upper part to a bottom part of the reaction tank. In another preferred aspect of the manufacturing method disclosed herein, the fine bubbles have an average particle diameter of 100 μm or less and the fine bubbles include at least ultrafine bubbles with a particle diameter of less than 1 μm. In still another preferred aspect, the manufacturing method disclosed herein further includes a step E of stirring the slurry in a downstream step relative to the step B.

With such a structure, reaction between carbon dioxide and calcium hydroxide can accelerated and thus, calcium carbonate can be manufactured more efficiently.

In a preferred aspect, the manufacturing method disclosed herein may further include a step F of extracting the supplied carbon dioxide and supplying the carbon dioxide again to the reaction tank through the fine bubble generation device in a downstream step relative to the step D. The step F may be performed by circulating the carbon dioxide using a second circulation line connected to the reaction tank and a carbon dioxide gas supplying means.

With such a structure, the manufacturing method for fixing the blown carbon dioxide as calcium carbonate more efficiently is achieved.

### BRIEF DESCRIPTION OF DRAWINGS

FIG. 1 is a diagram schematically illustrating a manufacturing apparatus for calcium carbonate according to one embodiment.

FIG. 2 is a diagram schematically illustrating a structure of a fine bubble generation device according to one embodiment.

FIG. 3 is a diagram schematically illustrating another example of the manufacturing apparatus for calcium carbonate according to one embodiment.

FIG. 4 is a diagram schematically illustrating a manufacturing apparatus for calcium carbonate according to another embodiment.

### DESCRIPTION OF EMBODIMENTS

Preferred embodiments of the present invention will hereinafter be described as appropriate with reference to the drawings. Matters that are other than matters particularly mentioned in the present specification and that are necessary for the implementation of the present invention can be grasped as design matters of those skilled in the art based on the prior art in the relevant field. The present invention can be implemented on the basis of the contents disclosed in the present specification and common technical knowledge in the relevant field. Moreover, in the present specification, the notation “A to B” for a numerical range signifies “A or more and B or less” unless otherwise stated in particular.

### 1. First Embodiment

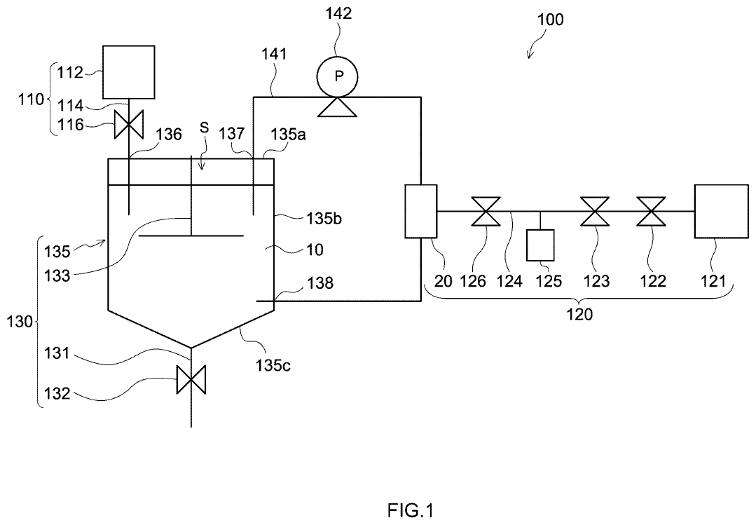

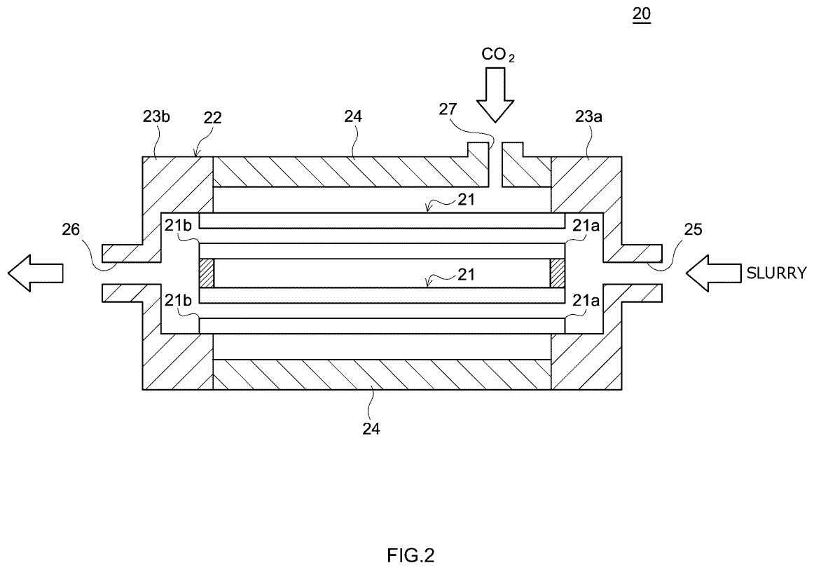

FIG. 1 is a diagram schematically illustrating a manufacturing apparatus 100 for calcium carbonate according to a first embodiment. FIG. 2 is a diagram schematically illustrating a structure of a fine bubble generation device 20 including a fine bubble generation tube 21 with a tubular shape that is formed of a porous body, which is used in the manufacturing apparatus 100 disclosed herein. Each structure of the manufacturing apparatus 100 disclosed herein will be described below with reference to FIG. 1 and FIG. 2.

As illustrated in FIG. 1, the manufacturing apparatus 100 includes a slurry supply unit 110, a carbon dioxide supply unit 120, and a calcium carbonate generation unit 130. The slurry supply unit 110 and the calcium carbonate generation unit 130 are connected to each other through a slurry supply line 114 configured to enable a slurry 10 to flow therein. The carbon dioxide supply unit 120 and the calcium carbonate generation unit 130 are connected to each other through a circulation line 141 configured to enable the slurry 10 and carbon dioxide to flow therein. The calcium carbonate generation unit 130 includes a collection line 131 that collects the generated calcium carbonate and that is connected to the slurry supply unit 110 and the carbon dioxide supply unit 120 through the slurry supply line 114 and the circulation line 141.

The manufacturing apparatus 100 for calcium carbonate according to the first embodiment includes a reaction tank 135 with the airtightness not to release carbon dioxide, the slurry supply unit 110 that supplies the slurry 10 to the reaction tank 135, the carbon dioxide supply unit 120 that includes the fine bubble generation device 20 for blowing fine bubbles of carbon dioxide into the slurry 10, and the circulation line 141 that includes a space where the slurry 10 can flow and that is formed through the reaction tank 135 and the fine bubble generation device 20. With such a structure, the apparatus that can fix carbon dioxide as calcium carbonate suitably and manufacture calcium carbonate safely is achieved.

Here, fixing carbon dioxide means converting carbon dioxide into a carbonate compound through chemical reaction with a solution or the like. For example, according to the art disclosed herein, fixing carbon dioxide means converting (fixing) carbon dioxide into calcium carbonate through chemical reaction between fine bubbles containing carbon dioxide and a slurry containing calcium hydroxide. By converting carbon dioxide into the useful carbonate compound in this manner, the amount of carbon dioxide emitted to the air can be reduced drastically and carbon dioxide can be recycled, which can contribute to solving the environmental problem such as global warming.

A supply (generation) source of carbon dioxide, which is the subject of fixation, is not limited in particular. For example, carbon dioxide emitted from factories, thermal electric power plants, automobiles, and the like may be collected and fixed as calcium carbonate.

The slurry supply unit 110 is to supply the slurry 10 containing calcium hydroxide to the calcium carbonate generation unit 130. The slurry supply unit 110 is not limited in particular as long as the slurry supply unit 110 is configured to be able to supply the slurry 10 to the calcium carbonate generation unit 130 (more specifically, the reaction tank 135). For example, as illustrated in FIG. 1, the slurry supply unit 110 can include a tank 112 that accumulates the slurry 10, the slurry supply line 114 that includes the space where the slurry 10 can flow, and a valve 116 that opens and closes the slurry supply line 114. The tank 112 accumulates the slurry 10 in which calcium hydroxide is dissolved or diffused in an aqueous solvent (for example, water) and by opening and closing the valve 116, a desired amount of slurry 10 is supplied to the calcium carbonate generation unit 130 through the slurry supply line 114.

The carbon dioxide supply unit 120 supplies a gas containing carbon dioxide to the calcium carbonate generation unit 130 connected through the circulation line 141. The gas to be supplied from the carbon dioxide supply unit 120 is preferably a gas containing 90% or more (more preferably 95% or more) of carbon dioxide (for example, carbonate gas). The carbon dioxide supply unit 120 includes at least the fine bubble generation device 20 that blows fine bubbles containing carbon dioxide into the slurry 10. This fine bubble generation device 20 includes the fine bubble generation tube 21 with the tubular shape that is formed of the porous body. The carbon dioxide supply unit 120 may include a gas cylinder 121 that accumulates a carbon dioxide gas (carbonate gas), a pressure adjustment valve 122 that adjusts the supply pressure of the carbon dioxide gas, a flow rate adjustment valve 123 that adjusts the flow rate of the carbon dioxide gas, a carbon dioxide supply line 124 that includes a space where carbon dioxide can flow, a flowmeter 125 that measures the flow rate of the carbon dioxide gas, and a valve 126 that opens and closes the carbon dioxide supply line 124.

The gas cylinder 121 temporarily accumulates the carbon dioxide gas (carbonate gas) to be fixed. The derivation of the carbon dioxide gas to be accumulated in the gas cylinder 121 (generation source of carbon dioxide gas) is not limited in particular. For example, emission gas containing carbon dioxide or the like generated in a factory or the like may be used. The carbon dioxide gas derived from the emission gas can be accumulated in the gas cylinder 121 by disposing a carbon dioxide absorber in the supply (generation) source of the emission gas as described above and releasing the adsorbed carbon dioxide with heat application using, for example, steam or the like. Examples of such a carbon dioxide absorbing material include a porous material, a chemical absorbing material with an amino group or the like having carbon dioxide absorbing capability introduced therein, a metal-organic framework (MOF), a carbonous material, and a carbon dioxide adsorbing material/absorbing material formed of alkali metal calcium carbonate or the like. Such a carbon dioxide absorbing material is easily reduced in size; therefore, the cost can be reduced compared to installing a pipe for introducing carbon dioxide directly from a factory or the like. In a preferred aspect, carbon dioxide adsorbed on the chemical absorbing material with the amino group or the like having the carbon dioxide absorbing capability introduced therein is preferably used.

The fine bubble generation device 20 illustrated in FIG. 2 includes the fine bubble generation tube 21 with the tubular shape that is formed of the porous body with micropores. The fine bubble generation tube 21 is connected to the circulation line 141, and the slurry 10 is supplied through this circulation line 141. The fine bubble generation tube 21 blows the carbon dioxide gas (carbonate gas) sent from the gas cylinder 121 as fine bubbles into the slurry 10. The number of fine bubble generation devices 20 to be disposed in the circulation line 141 may be either one or more than one.

In the description below, an end part of the fine bubble generation tube 21 in one direction along a flowing direction of the slurry 10 may be referred to as an upstream side end part 21a (end part on a right side in FIG. 2) and an end part thereof in the other direction may be referred to as a downstream side end part 21b (end part on a left side in FIG. 2).

The fine bubble generation device 20 includes one or a plurality of (here, a plurality of) fine bubble generation tubes 21, and a base material part 22 that surrounds the fine bubble generation tubes 21. The shape of the fine bubble generation tube 21 is not limited in particular as long as the fine bubble generation tube 21 includes a space where the slurry can flow. The fine bubble generation tube 21 has, for example, a circular cross-sectional shape and may be a circular tube extending linearly. Note that the shape of the fine bubble generation tube 21 is not limited to this shape; for example, the cross-sectional shape may be a square shape such as a tetragonal or hexagonal shape, or the shape may be different in diameter on the upstream side and the downstream side (for example, conical shape). The fine bubble generation tube 21 may have an outer diameter R1 of about 3 mm to 16 mm and an inner diameter R2 of about 1 mm to 12 mm, for example. An effective length L of the fine bubble generation tube 21 (that is, the length of a part that can supply the carbon dioxide gas to the slurry 10 flowing inside the fine bubble generation tube 21) is preferably about 50 mm to 1000 mm, for example. By inputting the gas (for example, carbonate gas) with pressure from the outside by using the fine bubble generation tube 21 with such a structure, fine bubbles containing carbon dioxide can be generated suitably in the slurry 10 flowing inside the fine bubble generation tube 21.

Here, in this specification, the term “fine bubbles containing carbon dioxide” refers to, for example, fine bubbles formed when the gas (carbonate gas) containing 90% or more (more preferably, 95% or more) of carbon dioxide is input with pressure to the fine bubble generation device 20. In this specification, the fine bubbles include at least microbubbles and ultrafine bubbles. The definition of the microbubbles and the ultrafine bubbles is based on the specification in accordance with International Organization for Standardization (ISO), and the microbubbles are bubbles with an average particle diameter of 1 μm or more and less than 100 μm and the ultrafine bubbles are bubbles with an average particle diameter of less than 1 μm.

In a preferred aspect, the fine bubble generation device 20 is preferably configured to generate fine bubbles having an average particle diameter of 100 μm or less and including at least the ultrafine bubbles with an average particle diameter of less than 1 μm.

In this specification, the term “average particle diameter” refers to the particle diameter (D50, also referred to as median diameter) corresponding to the cumulative frequency 50 number % from the microparticle side with small particle diameter in the particle size distribution based on the number in accordance with a general image analysis method. Such an image analysis method can be performed using, for example, a dynamic image analysis type particle shape/particle size distribution measurement device.

The fine bubble generation tube 21 is formed of a porous body including communicating pores and having a porosity of about 20 to 60%. Examples of materials of the porous body include oxide-based ceramics such as alumina (Al₂O₃), zirconia (ZrO₂), magnesia (MgO), silica (SiO₂), titania (TiO₂), zircon (ZrSiO₄), and mullite (Al₆O₁₃Si₂), non-oxide-based ceramics such as silicon nitride (Si₃N₄), boron nitride (BN), aluminum nitride (AlN), silicon carbide (SiC), and boron carbonitride, a complex material containing at least one or more kinds of these ceramics, and the like. In particular, alumina, boehmite, silica, and titania, which are stable in quality, inexpensive, and easily obtained, are preferably used. Note that the chemical formula shown in parenthesis after the name of the substance expresses the representative composition of the substance and it is not intended to limit the actual composition of the ceramic to the shown chemical formula.

The average pore diameter of the fine bubble generation tube 21 is not limited in particular as long as the fine bubbles including the ultrafine bubbles and the microbubbles described above can be generated. For example, the average pore diameter of the fine bubble generation tube 21 is preferably 0.5 μm or more and more preferably 1 μm or more, and may be 1.3 μm or more or 3 μm or more. If the average pore diameter is too large, the fine bubbles (bubbles) with the desired size cannot be generated; thus, for example, the average pore diameter is preferably 10 μm or less and more preferably 9.4 μm or less, and may be 7 μm or less. Note that the average pore diameter of the fine bubble generation tube 21 can be measured by, for example, a mercury intrusion method.

The base material part 22 includes an upstream side supporting part 23a that supports the upstream side end part 21a of the fine bubble generation tube 21, a downstream side supporting part 23b that supports the downstream side end part 21b, and a trunk part 24 that is attached between the upstream side supporting part 23a and the downstream side supporting part 23b and surrounds one or a plurality of fine bubble generation tubes 21. The upstream side supporting part 23a includes at least one slurry inlet 25, and the downstream side supporting part 23b includes at least one slurry outlet 26. The trunk part 24 includes at least one carbon dioxide inlet 27. The carbon dioxide gas accumulated in the gas cylinder 121 is supplied from the carbon dioxide inlet 27 with the pressure applied by the pressure adjustment valve 122, so that the fine bubbles containing carbon dioxide can be blown into the slurry 10 that passes the fine bubble generation tube 21.

The calcium carbonate generation unit 130 generates (precipitates) calcium carbonate by causing a reaction between the slurry 10 containing calcium hydroxide supplied from the slurry supply unit 110 and the fine bubbles containing carbon dioxide supplied from the carbon dioxide supply unit 120. The calcium carbonate generation unit 130 includes the reaction tank 135 here as a container with the airtightness of such a degree that at least carbon dioxide is not released. The calcium carbonate generation unit 130 includes the collection line 131 for collecting the slurry 10 containing the generated calcium carbonate and a valve 132 for opening and closing the collection line 131. The calcium carbonate generation unit 130 may further include a stirring machine 133.

The reaction tank 135 is not limited in particular as long as the reaction tank 135 is configured to be able to accumulate the slurry 10 and not to release carbon dioxide into the air. For example, the reaction tank 135 can be airtightly sealed to such a degree that carbon dioxide is not released into the air. As illustrated in the drawing, the reaction tank 135 includes an upper part 135a, a side wall part 135b, and a bottom part 135c. The upper part 135a includes at least one input port 136 and the slurry supply line 114 is connected to this input port 136. The slurry 10 is input through the slurry supply line 114 and the input port 136. The upper part 135a includes at least one first connection part 137 to be connected to the circulation line 141. The bottom part 135c of the reaction tank 135 includes at least one second connection part 138 to be connected to the circulation line 141. However, the second connection part 138 may alternatively be provided on the side wall part 135b. In the case where the second connection part 138 is provided on the side wall part 135b, the second connection part 138 is preferably provided on a lower side of the side wall part 135b (near the bottom part 135c). Note that the slurry supply line 114 and the input port 136 are connected to each other with the airtightness secured to such a degree that carbon dioxide is not released from the reaction tank 135. In addition, the circulation line 141, and the first connection part 137 and the second connection part 138 are connected to each other with the airtightness secured to such a degree that carbon dioxide is not released from the reaction tank 135.

The reaction tank 135 has the pressure resistance to resist a maximum pressure (MPa) of about 0.3 MPa or less in the container, for example. The material of the reaction tank 135 is not limited in particular and may be, for example, stainless steel or the like.

The shape of the reaction tank 135 is not limited in particular and, for example, may be an approximately cylindrical shape or an approximately rectangular parallelepiped shape. The reaction tank 135 may be an approximately cylindrical container whose ratio (H/D) of a height H of the container to an inner diameter D of the container is about 1.0 to 1.5, for example. Alternatively, the reaction tank 135 may be an approximately cylindrical container that is long in a height direction and has the ratio (H/D) of the height H of the container to the inner diameter D of the container of about more than 1.5 and 2 or less. The bottom part 135c of the reaction tank 135 may have a shape that protrudes downward in the height direction in a cross-sectional view along the height direction of the reaction tank 135. That is to say, the bottom part 135c may be configured to have the inclination from a lower end of the side wall part 135b to a central part of the reaction tank 135. Thus, the generated calcium carbonate can be collected easily.

The reaction tank 135 may include the stirring machine 133 to stir the slurry 10. The stirring machine 133 is not limited in particular and may have a predetermined pressure resistance. The stirring machine 133 includes, for example, a stirring blade and a motor connected to the stirring blade through a stirring shaft. In the stirring machine 133, a periphery of the stirring shaft is preferably sealed airtightly by an oil seal, a dry gas seal, or the like in order to prevent carbon dioxide from being released from between the stirring shaft and a bearing part for the stirring shaft. The oil seal and the dry gas seal generally have a pressure resistance of about 0.3 MPa to 0.5 MPa. By the manufacturing apparatus disclosed herein, carbon dioxide can be supplied so that the pressure will not exceed the pressure resistance of the oil seal or the dry gas seal.

It is only necessary that an outer diameter r1 of the stirring blade of the stirring machine 133 is set so as to be able to stir the slurry sufficiently and there is no particular limitation. In one example, a ratio (r1/r2) of the outer diameter r1 of the stirring blade to an inner diameter r2 of the reaction tank 135 is preferably about 0.4 to 0.8.

The circulation line 141 includes the space where the slurry 10 can flow. The circulation line 141 has one end part connected to the first connection part 137 described above and the other end part connected to the second connection part 138. The inner diameter of the circulation line 141 is not limited in particular as long as the slurry 10 can flow, and it is preferable that this inner diameter be not largely different from the inner diameter R2 of the fine bubble generation tube 21. For example, the inner diameter of the circulation line 141 may be about 3 mm to 12 mm.

The circulation line 141 is not limited in particular as long as the slurry can be circulated passing a route between the reaction tank 135 and the fine bubble generation device 20. The circulation line 141 includes a suction pump 142 for circulating the slurry 10, for example. By operation of the suction pump 142, the slurry 10 can be circulated so that the slurry 10 supplied to the reaction tank 135 is supplied from the first connection part 137 to the circulation line 141, passes the carbon dioxide supply unit 120 (more specifically, fine bubble generation device 20), and is input again into the reaction tank 135 from the second connection part 138. Alternatively, by operation of the suction pump 142, the slurry 10 can be circulated so that the slurry 10 supplied to the reaction tank 135 is supplied from the second connection part 138 to the circulation line 141, passes the carbon dioxide supply unit 120 (more specifically, fine bubble generation device 20), and is input again into the reaction tank 135 from the first connection part 137. In the circulation line 141, the suction pump 142 may be provided between the first connection part 137 and the fine bubble generation device 20. In the circulation line 141, the suction pump 142 may alternatively be provided between the second connection part 138 and the fine bubble generation device 20. The circulation line 141 may be configured so as to circulate the slurry 10 from the upper part 135a side to the bottom part 135c side of the reaction tank 135. The circulation line 141 may alternatively be configured so as to circulate the slurry 10 from the bottom part 135c side to the upper part 135a side of the reaction tank 135.

In a preferred aspect, the circulation line 141 is configured so as to circulate the slurry 10 from the upper part 135a side to the bottom part 135c side of the reaction tank 135. For example, as illustrated in FIG. 1, the circulation line 141 can be configured so as to circulate the slurry 10 from the upper part 135a to the bottom part 135c of the reaction tank 135 in such a way that the suction pump 142 is provided between the first connection part 137 and the fine bubble generation device 20. With such a structure, the fine bubbles containing carbon dioxide supplied from the carbon dioxide supply unit 120 described above are supplied from the bottom part 135c of the reaction tank 135 together with the slurry 10. Since the supplied fine bubbles go up and suitably react with the slurry 10 accumulated in the reaction tank 135, calcium carbonate is generated more efficiently. In the case where the slurry 10 is supplied from the bottom part 135c of the reaction tank 135 through the circulation line 141, the shape of the reaction tank 135 is more preferably, for example, an approximately cylindrical shape that is long in the height direction as described above (that is, the ratio of the height H of the container to the inner diameter D of the container is about more than 1.5 and 2 or less). Thus, the time for which carbon dioxide supplied as the fine bubbles together with the slurry floats and transfers in the slurry 10 can be secured long, making it possible to manufacture calcium carbonate more efficiently.

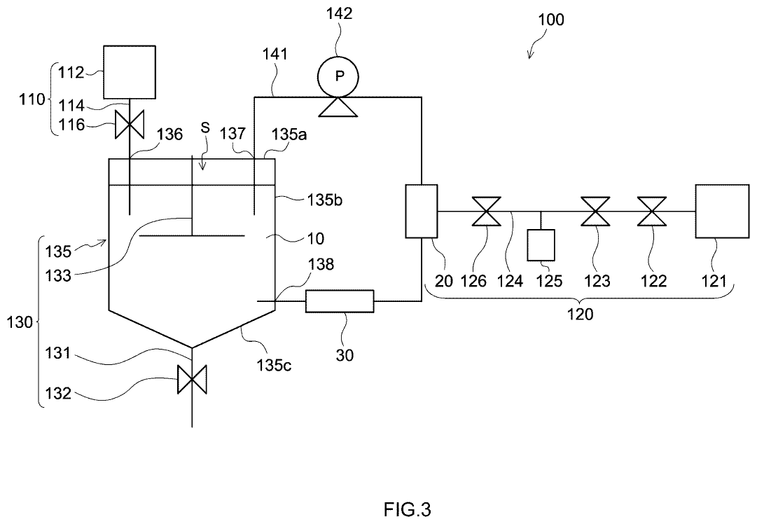

In the case where the circulation line 141 is configured so as to circulate the slurry 10 from the upper part 135a side to the bottom part 135c side of the reaction tank 135, as illustrated in FIG. 3, the circulation line 141 more preferably includes an inline mixer 30 on the downstream side relative to the fine bubble generation device 20. The inline mixer 30 may be any stationary type mixing device not including a driving unit, without particular limitations. Examples thereof include a static mixer, a Ramond super mixer, a Sulzer mixer, and the like. In particular, a static mixer type inline mixer is preferable. Thus, calcium hydroxide in the slurry 10 and the supplied fine bubbles containing carbon dioxide are mixed more suitably, so that the reaction time can be shortened. The number of such inline mixers 30 provided in the circulation line 141 may be either one or more than one.

Calcium carbonate generated in the reaction tank 135 can be collected by opening the valve 132 of the collection line 131. Calcium carbonate to be collected here is collected in a state of a suspension in which calcium carbonate is diffused in liquid. Such a suspension is accumulated, concentrated, and dried, for example, as necessary using a conventionally known device, so that the suspension can be processed and used in a desired mode. By additionally blowing carbon dioxide with higher purity (for example, 99% or more) into the collected suspension, the carbonation rate can be increased. Note that the term “carbonation rate” in this specification refers to the amount of substance of precipitated calcium carbonate relative to the amount of substance of calcium hydroxide used when the slurry is adjusted.

The apparatus of manufacturing calcium carbonate suitably has been described. By such a manufacturing apparatus, even if the reaction tank 135 with the airtightness not to release carbon dioxide is used, calcium carbonate can be manufactured without excessively increasing the pressure in the container. Therefore, carbon dioxide can be fixed more suitably and calcium carbonate can be manufactured safely. By such an apparatus, moreover, carbon dioxide will not be released into the air; thus, a system presenting the amount of fixed carbon dioxide can be constructed using this apparatus.

Hereinafter, a method of manufacturing calcium carbonate using the manufacturing apparatus 100 will be described.

A manufacturing method for calcium carbonate disclosed herein includes: a step A of preparing a slurry containing calcium hydroxide; a step B of supplying the slurry to a reaction tank with airtightness not to release carbon dioxide; a step C of circulating the slurry supplied to the reaction tank, using a circulation line connected to the reaction tank and a fine bubble generation device; and a step D of blowing fine bubbles containing carbon dioxide into the slurry using the fine bubble generation device. When the flow rate of the slurry in the circulation line is a flow rate X (ml/min) and the supply rate of a carbon dioxide gas to the fine bubble generation device is a supply rate Y (ml/min), the carbon dioxide gas is supplied from the outside to the fine bubble generation tube 21 so that the ratio (Y/X) of the supply rate Y of the carbon dioxide gas to the flow rate X of the slurry becomes 1 or less and carbon dioxide is blown as the fine bubbles into the slurry 10 flowing in the fine bubble generation tube 21. A step E of stirring the supplied slurry 10 may be provided in a downstream step relative to the step B. In this manufacturing method, calcium carbonate can be manufactured safely and simply even in a container (for example, reaction tank) with the airtightness of such a degree that carbon dioxide is not released. Since carbon oxide is not released to the air, carbon dioxide can be fixed as calcium carbonate suitably. The manufacturing method disclosed herein is characterized in that the flow rate X of the slurry and the supply rate Y of the carbon dioxide gas to the fine bubble generation tube are adjusted as described above, and except this adjustment, the manufacturing process for calcium carbonate may be similar to the conventional one. Another step may be further provided at an optional stage.

The step A is a step of preparing the slurry containing calcium hydroxide, which is a mw material of calcium carbonate. The slurry prepared in this step is in a mode of a slurry composition or a dispersion liquid in which calcium hydroxide is dispersed in a liquid medium such as an aqueous solvent. Here, the aqueous solvent may be, for example, water or a mixed solution of water and alcohol. As the aqueous solvent, ion exchange water (deionized water), pure water, ultrapure water, distilled water, or the like can be preferably used.

The concentration of calcium hydroxide of the slurry containing calcium hydroxide prepared in the step A is preferably 0.1 mol/L or more and more preferably 0.5 mol/L or more, and may be 1 mol/L or more. The upper limit of the concentration of calcium hydroxide is preferably 4 mol/L or less and more preferably 3 mol/L or less, and may be 2 mol/L or less. Within this concentration range, carbon dioxide supplied as the fine bubbles and calcium hydroxide in the slurry react with each other suitably and calcium carbonate can be manufactured stably. The pH of the slurry prepared in the preparing step is not limited in particular and is preferably adjusted to be about 12 or more and 13 or less, for example.

In the step B, the prepared slurry 10 is supplied to the reaction tank 135. The step B as described above is not limited in particular as long as the slurry 10 is supplied to the reaction tank 135. In one example, first, the prepared slurry 10 is accumulated in the tank 112. Next, the valve 132 of the collection line 131 is closed and the suction pump 142 is stopped, and in this state, the valve 116 of the slurry supply line 114 is opened to supply the slurry 10 to the reaction tank 135. Note that the quantity of slurry 10 to be supplied to the reaction tank 135 is not limited in particular. For example, the supply rate is preferably adjusted so that a space S is formed near the upper part 135a of the reaction tank 135.

In the step C, the slurry 10 supplied to the reaction tank 135 is circulated using the circulation line 141 formed passing the reaction tank 135 and the fine bubble generation device 20. For example, by operating the suction pump 142 included in the circulation line 141, the slurry 10 can be circulated. In a preferred aspect, the slurry 10 is circulated from the upper part 135a to the bottom part 135c of the reaction tank 135 in the step C. For example, when the suction pump 142 provided between the first connection part 137 and the fine bubble generation device 20 is operated, the slurry 10 is sucked from the first connection part 137 and flows in the circulation line 141. Then, the slurry 10 passes the fine bubble generation device 20 (more specifically, inside the fine bubble generation tube 21) and is input again from the second connection part 138 to the reaction tank 135. Thus, the fine bubbles containing carbon dioxide supplied from the fine bubble generation device 20 are supplied together with the slurry 10 from the bottom part 135c side of the reaction tank 135 in the step D to be described below. Therefore, the fine bubbles supplied together with the slurry 10 react suitably with the accumulated slurry 10 while the fine bubbles go up in the reaction tank 135. With such a structure, the manufacturing time for calcium carbonate can be shortened while the excessive increase in pressure of the reaction tank 135 is suppressed.

Although there is no particular limitation, the reaction tank 135 may include a liquid level sensor and be configured so that the suction pump 142 is automatically operated when the supplied slurry 10 reaches a predetermined quantity.

In the step D, the fine bubbles containing carbon dioxide are blown into the slurry 10 using the fine bubble generation device 20 described above. At this time, this step is performed so that the ratio (Y/X) of the supply rate Y of the carbon dioxide gas supplied to the fine bubble generation device 20 to the flow rate X of the slurry circulating in the circulation line 141 becomes 1 or less. The ratio (Y/X) of the supply rate Y of the carbon dioxide gas to the flow rate X of the slurry is preferably 0.8 or less and more preferably 0.76 or less, and may be 0.6 or less. In consideration of reducing the energy for circulating the slurry 10 and the reaction time, the lower limit of the ratio (Y/X) of the supply rate Y of the carbon dioxide gas to the flow rate X of the slurry is preferably 0.16 or more and more preferably 0.2 or more, and may be 0.29 or more, 0.43 or more, or 0.51 or more, for example. By controlling the flow rate X of the slurry and the supply rate Y of the carbon dioxide gas to be within the aforementioned range, the excessive pressure increase can be suppressed suitably; thus, calcium carbonate can be manufactured safely even in the reaction tank with the airtightness not to release carbon dioxide. Accordingly, it is possible to fix carbon dioxide as calcium carbonate without releasing carbon dioxide to the outside.

Regarding the flow rate X (ml/min) of the slurry in the circulation line 141 and the supply rate Y (ml/min) of the carbon dioxide gas, for example, the flow rate X of the slurry may be about 100 ml/min or more and 2500 ml/min or less and the supply rate Y of the carbon dioxide gas may be about 100 ml/min or more and 700 ml/min or less. The flow rate X of the slurry in the circulation line 141 and the supply rate Y of the carbon dioxide gas are not limited in particular as long as the aforementioned (Y/X) is satisfied, and can be set as appropriate in consideration of the size of the container, the inner diameter of the circulation line 141, and the like. For example, even if the flow rate X of the slurry and the supply rate Y of the carbon dioxide gas are over the aforementioned range, calcium carbonate can be manufactured suitably as long as the flow rate X of the slurry and the supply rate Y of the carbon dioxide gas are controlled so as to satisfy the aforementioned (Y/X) range.

In the reaction with calcium hydroxide in the slurry, the supply rate Y of the carbon dioxide gas may be constant or may be adjusted within the range of satisfying the aforementioned (Y/X) in accordance with the reacting speed of carbon dioxide and calcium hydroxide. Note that the reacting speed can be monitored by measuring the pH of the slurry, for example. Although there is no particular limitation, the supply rate Y of the carbon dioxide gas may be adjusted so as to decrease in accordance with the reacting speed from an initial stage of the reaction (that is, stage with higher pH) to a later stage of the reaction (that is, stage with lower pH) within the range satisfying the aforementioned (Y/X).

The supply pressure (MPa) of the carbon dioxide gas is set as appropriate by the pressure adjustment valve 122. The supply pressure of the carbon dioxide gas can be set to the supply pressure at which the ultrafine bubbles are generated easily. When the pressure in a bubble point test in distilled water in the fine bubble generation device installed in the container is 0, the pressure difference between the supply pressure of the carbon dioxide gas and the pressure in the container is preferably 0.01 MPa or more and 0.8 MPa or less, more preferably 0.04 MPa or more and 0.6 MPa or less, and particularly preferably 0.06 MPa or more and 0.4 MPa or less, for example. By controlling the supply pressure in the aforementioned range, the fine bubbles containing carbon dioxide are supplied in a mode including the ultrafine bubbles; therefore, the specific surface area with calcium hydroxide in the slurry can be increased. Thus, the reaction between carbon dioxide and calcium hydroxide progresses suitably and the reaction time can be shortened. Note that there is a suitable range for the pressure difference between the supply pressure of the carbon dioxide gas and the pressure in the reaction tank for each average pore diameter of the fine bubble generation tube 21, and if the supply pressure of the carbon dioxide gas is too high, the ultrafine bubbles are not generated and millimeter-size bubbles with an average particle diameter of 100 μm or more are generated, which may result in the lower reacting speed or the sudden increase in pressure in the container.

In a preferred aspect, the average particle diameter of the fine bubbles containing carbon dioxide to be supplied in the step D is 100 μm or less and the ultrafine bubbles with an average particle diameter of less than 1 μm are included. Thus, the gas-liquid contact area is increased, so that the reacting speed of carbon dioxide and calcium hydroxide in the slurry can be improved. With such a structure, carbon dioxide can be fixed as calcium carbonate more efficiently.

In a preferred aspect, the step E of stirring the slurry is included in order to increase the reacting speed of the supplied carbon dioxide and calcium hydroxide in the slurry. In the step E, for example, the conventionally used stirring machine, such as a stirring machine with a stirring blade (also called blade), can be used as appropriate. The stirring speed of the stirring machine is not limited in particular and may be, for example, about 0.5 to 1.5 m/s.

In the manufacturing method disclosed herein, the slurry 10 is circulated using the suction pump 142 as described above. Thus, the effect of stirring the inside of the reaction tank 135 can also be obtained. In addition, by blowing the fine bubbles containing carbon dioxide into the slurry using the fine bubble generation device 20, the slurry can be stirred while carbon dioxide is supplied into the slurry. Accordingly, the energy for operating the stirring machine can be reduced and the emission of carbon dioxide can be suppressed compared to that in the conventional manufacturing method.

The manufacturing method disclosed herein may further include a step of blowing carbon dioxide in a downstream step relative to the step D. Such a step can be performed by blowing carbon dioxide in accordance with a conventionally known method. At this time, the exhaust gas emitted from the factory or the like may be used as the carbon dioxide gas to be blown. Thus, the amount of carbon dioxide to be emitted into the air can be reduced further. In the case of using the exhaust gas as the carbon dioxide gas, it is preferable to use the gas with dust removed therefrom using a filter or the like.

The manufacturing method disclosed herein may include a step of collecting the generated calcium carbonate in a downstream step relative to the step D. This collecting step can be performed in accordance with a conventionally known method such as filtering. The collected calcium carbonate can be used in the industries of pigments, paints, rubber, paper manufacture, and the like.

By the aforementioned structure, carbon dioxide can be fixed as calcium carbonate by the safe and simple method even in the container with the airtightness not to release carbon dioxide to the air. In the manufacturing method disclosed herein, calcium carbonate is fixed in the container configured airtightly so as not to release carbon dioxide to the air; therefore, by measuring the amount of carbon dioxide supplied in the step D, the amount of carbon dioxide fixed as calcium carbonate can be calculated. That is to say, by the manufacturing method disclosed herein, it is possible to explicitly show how much carbon dioxide was fixed as calcium carbonate.

### 2. Second Embodiment

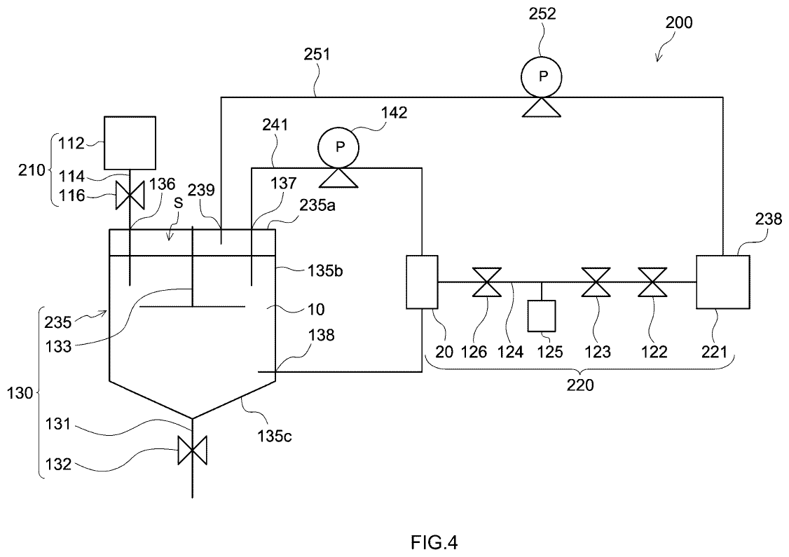

Next, a manufacturing apparatus 200 for calcium carbonate according to a second embodiment is described. In the second embodiment, as illustrated in FIG. 4, the manufacturing apparatus 200 for calcium carbonate includes a reaction tank 235 with the airtightness not to release carbon dioxide to the air, a slurry supply unit 210 that supplies the slurry 10 into the reaction tank 235, a carbon dioxide supply unit 220 including the fine bubble generation device 20 that blows carbon dioxide as fine bubbles into the slurry 10, a first circulation line 241 that includes a space where the slurry 10 can flow and that is formed through the reaction tank 235 and the fine bubble generation device 20, and a second circulation line 251 formed through the reaction tank 235 and a carbon dioxide supplying means that supplies the carbon dioxide gas to the fine bubble generation device 20. The first circulation line 241 may further include an inline mixer for stirring the slurry 10 and carbon dioxide.

The second embodiment is different from the first embodiment in that the second circulation line 251 including the space where carbon dioxide can flow is provided. The other structures of the apparatus may be similar to those described in the first embodiment; thus, the description of the overlapping contents is omitted.

Here, carbon dioxide blown as the fine bubbles from the fine bubble generation device 20 in the first circulation line 241 is supplied to the reaction tank 235 together with the slurry 10 through the first circulation line 241. As described above, since carbon dioxide is blown into the slurry 10 as the fine bubbles, the reacting speed with calcium hydroxide in the slurry 10 is higher than that in the conventionally known method (that is, a method in which carbon dioxide gas is not blown as the fine bubbles). However, since the reacting speed of carbon dioxide and calcium hydroxide in the slurry 10 decreases in the later stage of the reaction, the blown carbon dioxide passes through the slurry 10 without reacting with calcium hydroxide and remains in the space S near an upper part 235a of the reaction tank 235 in some cases. From the viewpoint of fixing carbon dioxide as calcium carbonate, it is preferable to collect carbon dioxide that remains in this way again and circulate carbon dioxide. In view of this, in the second embodiment, the second circulation line 251 for circulating carbon dioxide is provided.

The second circulation line 251 includes a second suction pump 252 for circulating carbon dioxide. The second circulation line 251 has one end part connected to an inlet 239 provided at the upper part 235a of the reaction tank 235 and the other end part connected to an outlet 238 provided at a gas cylinder 221. That is to say, the second circulation line 251 is formed through the reaction tank 235 and the carbon dioxide supply unit 220.

In the second embodiment, the step F of extracting the supplied carbon dioxide, supplying carbon dioxide to a carbon dioxide gas supplying means, and supplying carbon dioxide again to the reaction tank 235 through the fine bubble generation device 20 can be provided in a downstream step relative to the step D described above. In the step F, carbon dioxide supplied to the reaction tank 235 is circulated using the second circulation line 251 formed through the reaction tank 235 and the carbon dioxide gas supplying means (here, gas cylinder 221). Specifically, by operating the second suction pump 252, carbon dioxide supplied to the reaction tank 235 is supplied from the inlet 239 to the second circulation line 251 and flows in the second circulation line 251. Then, carbon dioxide is supplied from the outlet 238 to the carbon dioxide supplying means (here, gas cylinder 221). Carbon dioxide supplied to the gas cylinder 221 is blown again as the fine bubbles containing carbon dioxide into the slurry 10 from the fine bubble generation device 20. Thus, carbon dioxide that is supplied from the carbon dioxide supply unit 220 and has not reacted yet with calcium hydroxide in the slurry 10 can be circulated. With such a structure, carbon dioxide supplied from the carbon dioxide supply unit 220 can be fixed more efficiently.

### TEST EXAMPLES

Although Examples related to the art disclosed herein will be described below, it is not intended to limit the art disclosed herein to these Examples.

### 1. First Test

In this test, a condition to manufacture calcium carbonate without excessively increasing the pressure in the reaction tank with the airtightness not to release carbon dioxide was examined. Specifically, the flow rate X (ml/min) of the slurry circulating in the circulation line and the supply rate Y (ml/min) of the carbon dioxide gas supplied to the fine bubble generation device were changed as appropriate and the maximum pressure (MPa) in the container (reaction tank) and the blowing time (min) of the carbon dioxide gas were measured.

### Example 1

Calcium carbonate was manufactured using the manufacturing apparatus for calcium carbonate as illustrated in FIG. 1. As the container, a reaction tank having a cylindrical columnar shape (with an inner diameter of 13.3 cm, a height of 25 cm, and a capacity of 3.4 L) with the airtightness not to release carbon dioxide was used. In the reaction tank, a stirring blade of +9 cm was set. As the fine bubble generation device, an inline type ceramic fine bubble generation device (manufactured by NORITAKE CO., LIMITED, in which the fine bubble generation tube has an average pore diameter of 1.3 μm, an inner diameter of 3 mm, and a length (L) of 100 mm) as illustrated in FIG. 2 was used. To the reaction tank having the cylindrical columnar shape, 1.5 L of a calcium hydroxide slurry of 0.5 mol/L was prepared and input. The calcium hydroxide slurry before the reaction started had a pH of about 12.55 to 12.6 and a temperature of 20° C. to 22° C. Next, the suction pump was operated to circulate the slurry accumulated in the reaction tank. At this time, the flow rate X of the slurry circulating in the circulation line was controlled to be 640 ml/min (the flow speed in the fine bubble generation tube was 1.5 m/s). Next, the carbon dioxide gas of 100%, the supply rate Y of which was controlled to be 370 ml/min, was supplied to the prepared fine bubble generation device, thereby blowing fine bubbles containing carbon dioxide into the slurry. Note that the supply pressure of carbon dioxide was controlled in the range of 0.155 MPa to 0.19 MPa so as to keep the difference in pressure from the inside of the container where the ultrafine bubbles were generated easily. The amount of blown carbon dioxide was integrated and after the fine bubbles containing carbon dioxide were blown until the stoichiometric amount, the blowing was stopped and the stirring with the stirring machine and the circulation with the suction pump were performed for five minutes. After the stirring and the circulation were stopped, the pH of the slurry in the reaction tank was measured and the measured pH was about 6.2 to 6.8. The blowing time (min) of the fine bubbles containing carbon dioxide and the maximum pressure (MPa) in the container after the blowing of the fine bubbles containing carbon dioxide was started and before the blowing was stopped were measured. The results are shown in Table 1.

### Example 2

In Example 2, an inline type ceramic fine bubble generation device including a fine bubble generation tube with an average pore diameter of 3.4 μm was used. The flow rate X of the slurry was 1370 ml/min (the flow speed in the fine bubble generation tube was 3.2 m/s) and the supply rate Y of the carbon dioxide gas was 480 ml/min. Note that the supply pressure of carbon dioxide was controlled in the range of 0.035 MPa to 0.08 MPa so as to keep the difference in pressure from the inside of the container where the ultrafine bubbles were generated easily. Except these, the process similar to that in Example 1 was performed to manufacture calcium carbonate. After the blowing of the fine bubbles containing carbon dioxide was stopped, the stirring and circulation for five minutes were performed; then, the pH of the slurry in the reaction tank was measured and the measured pH was about 6.2 to 6.8. Moreover, the blowing time (min) of the fine bubbles containing carbon dioxide and the maximum pressure (MPa) in the container were measured. The results are shown in Table 1.

### Example 3

In Example 3, an inline type ceramic fine bubble generation device including a fine bubble generation tube with an average pore diameter of 9.4 μm was used. The flow rate X of the slurry was 550 ml/min (the flow speed in the fine bubble generation tube was 1.3 m/s) and the supply rate Y of the carbon dioxide gas was 420 ml/min. Note that the supply pressure of carbon dioxide was controlled in the range of 0.01 MPa to 0.026 MPa so as to keep the difference in pressure from the inside of the container where the ultrafine bubbles were generated easily. Except these, the process similar to that in Example 1 was performed to manufacture calcium carbonate. After the blowing of the fine bubbles containing carbon dioxide was stopped, the stirring and circulation for five minutes were performed; then, the pH of the slurry in the reaction tank was measured and the measured pH was about 6.2 to 6.8. Moreover, the blowing time (min) of the fine bubbles containing carbon dioxide and the maximum pressure (MPa) in the container were measured. The results are shown in Table 1.

### Example 4

In Example 4, the concentration of the calcium hydroxide slurry was changed to 1 mol/L. The flow rate X of the slurry was 140 ml/min (the flow speed in the fine bubble generation tube was 0.32 m/s) and the supply rate Y of the carbon dioxide gas was 100 ml/min. Except these, the process similar to that in Example 1 was performed to manufacture calcium carbonate. After the blowing of the fine bubbles containing carbon dioxide was stopped, the stirring and circulation for five minutes were performed; then, the pH of the slurry in the reaction tank was measured and the measured pH was about 6.2 to 6.8. Moreover, the blowing time (min) of the fine bubbles containing carbon dioxide and the maximum pressure (MPa) in the container were measured. The results are shown in Table 1.

### Example 5

In Example 5, an inline type ceramic fine bubble generation device including a fine bubble generation tube with an average pore diameter of 3.4 μm was used. The flow rate X of the slurry was 920 ml/min (the flow speed in the fine bubble generation tube was 2.1 m/s) and the supply rate Y of the carbon dioxide gas was 400 ml/min. Note that the supply pressure of carbon dioxide was controlled in the range of 0.035 MPa to 0.08 MPa so as to keep the difference in pressure from the inside of the container where the ultrafine bubbles were generated easily. Except these, the process similar to that in Example 4 was performed to manufacture calcium carbonate. After the blowing of the fine bubbles containing carbon dioxide was stopped, the stirring and circulation for five minutes were performed; then, the pH of the slurry in the reaction tank was measured and the measured pH was about 6.2 to 6.8. Moreover, the blowing time (min) of the fine bubbles containing carbon dioxide and the maximum pressure (MPa) in the container were measured. The results are shown in Table 1.

### Example 6

In Example 6, the flow rate X of the slurry was 180 ml/min (the flow speed in the fine bubble generation tube was 0.43 m/s) and the supply rate Y of the carbon dioxide gas was 210 ml/min. Except this, the process similar to that in Example 4 was performed to manufacture calcium carbonate. In Example 6, at the time point when 100 minutes passed after the blowing of the fine bubbles containing carbon dioxide started, the pressure in the reaction tank exceeded 0.3 MPa; thus, the blowing of the fine bubbles containing carbon dioxide was stopped before the stoichiometric amount was obtained. The pH of the slurry in the reaction tank at the time the blowing was stopped was measured and the measured pH was about 11.6. Moreover, the blowing time (min) of the fine bubbles containing carbon dioxide until the blowing was stopped is shown in Table 1.

### Example 7

In Example 7, calcium carbonate was manufactured without the installation of the stirring machine. The flow rate X of the slurry was 1920 ml/min (the flow speed in the fine bubble generation tube was 4.5 m/s) and the supply rate Y of the carbon dioxide gas was 400 ml/min. Except these, the process similar to that in Example 4 was performed to manufacture calcium carbonate. After the blowing of the fine bubbles containing carbon dioxide was stopped, the stirring and circulation for five minutes were performed; then, the pH of the slurry in the reaction tank was measured and the measured pH was about 6.2 to 6.8. Moreover, the blowing time (min) of the fine bubbles containing carbon dioxide and the maximum pressure (MPa) in the container were measured. The results are shown in Table 1.

TABLE 1

| | | | | | | | | Maximum | |
|---|---|---|---|---|---|---|---|---|---|
| | | | Average pore | Flow rate X | Supply rate Y | | Flow | pressure in | Blowing |
| | Stirring | Concentration | diameter | of slurry | of gas | | speed | container | time |
| | machine | (mol/L) | (μm) | (ml/min) | (ml/min) | Y/X | (m/s) | (MPa) | (min) |
| Example 1 | Present | 0.5 | 1.3 | 640 | 370 | 0.58 | 1.5 | 0.03 | 45 |
| Example 2 | Present | 0.5 | 3.4 | 1370 | 480 | 0.35 | 3.2 | 0.03 | 35 |
| Example 3 | Present | 0.5 | 9.4 | 550 | 420 | 0.76 | 1.3 | 0.15 | 40 |
| Example 4 | Present | 1 | 1.3 | 140 | 100 | 0.71 | 0.32 | 0.08 | 340 |
| Example 5 | Present | 1 | 3.4 | 920 | 400 | 0.43 | 2.1 | 0.05 | 85 |
| Example 6 | Present | 1 | 1.3 | 180 | 210 | 1.17 | 0.43 | Stopped because | 100 (stopped |
| | | | | | | | | of exceeding | before |
| | | | | | | | | 0.3 MPa | completion) |
| Example 7 | Absent | 1 | 1.3 | 1920 | 400 | 0.21 | 4.5 | 0.12 | 85 |

Table 1 indicates that, in the case of controlling the supply rate Y of the carbon dioxide gas and the flow rate X of the slurry so that the ratio (Y/X) of the supply rate Y of the carbon dioxide gas to the flow rate X of the slurry becomes 1 or less, calcium carbonate can be manufactured without excessively increasing the maximum pressure in the container (for example, with the maximum pressure in the container less than or equal to 0.3 MPa). As described in Example 6, in the case where the flow rate X of the slurry was lower than the supply rate Y of the carbon dioxide gas, the reacting speed between calcium hydroxide and carbon dioxide was high and the pressure did not increase just after the reaction started; however, as the reaction progressed, the reacting speed decreased and the supply of carbon dioxide tended to become excessive. Accordingly, it is presumed that the fine bubbles containing carbon dioxide merged in the generator of the fine bubble generation device, for example, which resulted in further decrease in reacting speed and thus, carbon dioxide was supplied to the reaction tank before sufficient reaction and therefore, the pressure in the container increased.

Therefore, by controlling the supply rate Y of the carbon dioxide gas and the flow rate X of the slurry so that the ratio (Y/X) of the supply rate Y of the carbon dioxide gas to the flow rate X of the slurry becomes 1 or less using the aforementioned manufacturing apparatus for calcium carbonate, calcium carbonate can be manufactured safely even when the container with the airtightness not to release carbon dioxide is used.

As described in Example 1 to Example 5, it is understood that in the case of controlling the supply rate Y of the carbon dioxide gas and the flow rate X of the slurry so that the ratio (Y/X) of the supply rate Y of the carbon dioxide gas to the flow rate X of the slurry becomes 1 or less, calcium carbonate can be manufactured without excessively increasing the pressure in the container regardless of the average pore diameter of the fine bubble generation device.

In addition, as described in Example 7, it is understood that even if the stirring machine is not installed, in the case of controlling the supply rate Y of the carbon dioxide gas and the flow rate X of the slurry so that the ratio (Y/X) of the supply rate Y of the carbon dioxide gas to the flow rate X of the slurry becomes 1 or less, calcium carbonate can be manufactured without excessively increasing the pressure in the container.

### 2. Second Test

In this test, a condition to manufacture calcium carbonate without excessively increasing the pressure in the container in a case where the concentration of the slurry containing calcium hydroxide was increased further was examined. Specifically, the concentration of the calcium hydroxide slurry was changed as appropriate in the range of 0.5 mol/L to 5 mol/L and the maximum pressure (MPa) in the container and the blowing time (min) of the fine bubbles containing carbon dioxide were measured.

### Example 11

Calcium carbonate was manufacturing using the manufacturing apparatus for calcium carbonate as illustrated in FIG. 1. As the container, a reaction tank similar to that in the first test was used. In the reaction tank, a stirring blade of #9 cm was set. As the fine bubble generation device, an inline type ceramic fine bubble generation device (manufactured by NORITAKE CO., LIMITED, in which the fine bubble generation tube has an average pore diameter of 1.3 μm, an inner diameter of 3 mm, and a length (L) of 100 mm) as illustrated in FIG. 2 was used. To the reaction tank having the cylindrical columnar shape, 1.5 L of a calcium hydroxide slurry of 2 mol/L was prepared and input. The calcium hydroxide slurry before the reaction started had a pH of about 12.55 to 12.6 and a temperature of 20° C. to 22° C. Next, the suction pump was operated to circulate the slurry accumulated in the reaction tank. At this time, the flow rate X of the slurry circulating in the circulation line was controlled to be 820 ml/min (the flow speed in the fine bubble generation tube was 1.9 m/s). Next, the carbon dioxide gas of 100%, the supply rate Y of which was controlled to be 420 ml/min, was supplied to the prepared fine bubble generation device, thereby blowing fine bubbles containing carbon dioxide into the slurry. Note that the supply pressure of carbon dioxide was controlled in the range of 0.155 MPa to 0.19 MPa so as to keep the difference in pressure from the inside of the container where the ultrafine bubbles were generated easily. The amount of blown carbon dioxide was integrated and after the fine bubbles containing carbon dioxide were blown until the stoichiometric amount, the blowing was stopped and the stirring with the stirring machine and the circulation with the suction pump were performed for five minutes. After the stirring and the circulation were stopped, the pH of the slurry in the reaction tank was measured and the measured pH was about 6.2 to 6.8.

The blowing time (min) of the fine bubbles containing carbon dioxide and the maximum pressure (MPa) in the container after the blowing of the fine bubbles containing carbon dioxide was started and before the blowing was stopped were measured. The results are shown in Table 2.

### Example 12

In Example 12, an inline type ceramic fine bubble generation device including a fine bubble generation tube with an average pore diameter of 3.4 μm was used. The flow rate X of the slurry was 1650 ml/min (the flow speed in the fine bubble generation tube was 3.9 m/s) and the supply rate Y of the carbon dioxide gas was 480 ml/min. Note that the supply pressure of carbon dioxide was controlled in the range of 0.035 MPa to 0.08 MPa so as to keep the difference in pressure from the inside of the container where the ultrafine bubbles were generated easily. Except these, the process similar to that in Example 11 was performed to manufacture calcium carbonate. After the blowing of the fine bubbles containing carbon dioxide was stopped, the stirring and circulation for five minutes were performed; then, the pH of the slurry in the reaction tank was measured and the measured pH was about 6.2 to 6.8. Moreover, the blowing time (min) of the fine bubbles containing carbon dioxide and the maximum pressure (MPa) in the container were measured. The results are shown in Table 2.

### Example 13

In Example 13, the concentration of the calcium hydroxide slurry was changed to 3 mol/L. The flow rate X of the slurry was 1370 ml/min (the flow speed in the fine bubble generation tube was 3.2 m/s) and the supply rate Y of the carbon dioxide gas was 420 ml/min. Except these, the process similar to that in Example 12 was performed to manufacture calcium carbonate. After the blowing of the fine bubbles containing carbon dioxide was stopped, the stirring and circulation for five minutes were performed; then, the pH of the slurry in the reaction tank was measured and the measured pH was about 6.2 to 6.8. Moreover, the blowing time (min) of the fine bubbles containing carbon dioxide and the maximum pressure (MPa) in the container were measured. The results are shown in Table 2.

### Example 14

In Example 14, the concentration of the calcium hydroxide slurry was changed to 4 mol/L. The flow rate X of the slurry was 1650 ml/min (the flow speed in the fine bubble generation tube was 3.9 m/s) and the supply rate Y of the carbon dioxide gas was 260 ml/min. Except these, the process similar to that in Example 11 was performed to manufacture calcium carbonate. After the blowing of the fine bubbles containing carbon dioxide was stopped, the stirring and circulation for five minutes were performed; then, the pH of the slurry in the reaction tank was measured and the measured pH was about 6.2 to 6.8. Moreover, the blowing time (min) of the fine bubbles containing carbon dioxide and the maximum pressure (MPa) in the container were measured. The results are shown in Table 2.

### Example 15

In Example 15, the concentration of the calcium hydroxide slurry was changed to 5 mol/L. In addition, the flow rate X of the slurry was 1650 ml/min (the flow speed in the fine bubble generation tube was 3.9 m/s) and the supply rate Y of the carbon dioxide gas was 200 ml/min. Except this, the process similar to that in Example 12 was performed to manufacture calcium carbonate. In Example 15, at the time point when 450 minutes passed after the blowing of the fine bubbles containing carbon dioxide started, the pressure in the reaction tank exceeded 0.3 MPa; thus, the blowing of the fine bubbles containing carbon dioxide was stopped before the stoichiometric amount was obtained. The pH of the slurry in the reaction tank at the time the blowing was stopped was measured and the measured pH was about 12.1.

### Example 16

In Example 16, calcium carbonate was manufactured by installing the inline mixer (static mixer manufactured by NORITAKE CO., LIMITED) in the circulation line as illustrated in FIG. 3. In addition, the flow rate X of the slurry was 1100 ml/min (the flow speed in the fine bubble generation tube was 2.6 m/s) and the supply rate Y of the carbon dioxide gas was 540 ml/min. Except this, the process similar to that in Example 12 was performed to manufacture calcium carbonate. After the blowing of the fine bubbles containing carbon dioxide was stopped, the stirring and circulation for five minutes were performed; then, the pH of the slurry in the reaction tank was measured and the measured pH was about 6.2 to 6.8. Moreover, the blowing time (min) of the fine bubbles containing carbon dioxide and the maximum pressure (MPa) in the container were measured. The results are shown in Table 2.

TABLE 2

| | | | | | | | | | Maximum | |
|---|---|---|---|---|---|---|---|---|---|---|
| | | | | Average pore | Flow rate X | Supply rate Y | | Flow | pressure in | Blowing |
| | Stirring | Line | Concentration | diameter | of slurry | of gas | | speed | container | time |
| | machine | mixer | (mol/L) | (μm) | (ml/min) | (ml/min) | Y/X | (m/s) | (MPa) | (min) |
| Example 1 | Present | Absent | 0.5 | 1.3 | 640 | 370 | 0.58 | 1.5 | 0.03 | 45 |
| Example 2 | Present | Absent | 0.5 | 3.4 | 1370 | 480 | 0.35 | 3.2 | 0.03 | 35 |
| Example 4 | Present | Absent | 1 | 1.3 | 140 | 100 | 0.71 | 0.32 | 0.08 | 340 |
| Example 5 | Present | Absent | 1 | 3.4 | 920 | 400 | 0.43 | 2.1 | 0.05 | 85 |
| Example 11 | Present | Absent | 2 | 1.3 | 820 | 420 | 0.51 | 1.9 | 0.05 | 160 |
| Example 12 | Present | Absent | 2 | 3.4 | 1650 | 480 | 0.29 | 3.9 | 0.05 | 140 |
| Example 13 | Present | Absent | 3 | 3.4 | 1370 | 420 | 0.31 | 3.2 | 0.08 | 240 |
| Example 14 | Present | Absent | 4 | 1.3 | 1650 | 260 | 0.16 | 3.9 | 0.30 | 520 |
| Example 15 | Present | Absent | 5 | 3.4 | 1650 | 200 | 0.12 | 3.9 | Stopped because | 450 (stopped |
| | | | | | | | | | of exceeding | before |
| | | | | | | | | | 0.3 MPa | completion) |
| Example 16 | Present | Present | 2 | 3.4 | 1100 | 540 | 0.49 | 2.6 | 0.05 | 125 |

Table 2 shows Example 1, Example 2, Example 4, and Example 5 for comparison. As described in Example 14, in the case where the slurry concentration was 4 mol/L, the slurry had high viscosity from the time point when the blowing of the fine bubbles containing carbon dioxide started and in order to generate the ultrafine bubbles suitably, it was necessary to increase the flow rate X of the slurry. On the other hand, since the blown carbon dioxide was not stirred sufficiently, it was necessary to set the supply rate Y of the carbon dioxide gas to be low in order to avoid the excessive supply of carbon dioxide. Accordingly, the ratio (Y/X) of the supply rate Y of the carbon dioxide gas to the flow rate X of the slurry was as small as 0.16. However, the fine bubbles containing carbon dioxide was able to be blown until the stoichiometric amount was obtained with the maximum pressure in the container not exceeding 0.3 MPa.

On the other hand, as described in Example 15, it is understood that the maximum pressure in the container exceeded 0.3 MPa when the slurry concentration was 5 mol/L. In the case where the slurry concentration was high, the ratio (Y/X) of the supply rate Y of the carbon dioxide gas to the flow rate X of the slurry was as small as 0.12 due to the similar reason. Moreover, it is presumed that as the reaction progressed, the slurry viscosity increased and the stirring became insufficient; thus, the reacting speed between calcium hydroxide and carbon dioxide decreased and accordingly, the pressure in the container increased.

In consideration of these results, it is preferable that the ratio (Y/X) of the supply rate Y of the carbon dioxide gas to the flow rate X of the slurry be 0.16 or more and 1 or less. In addition, the concentration of the calcium hydroxide slurry is preferably 0.1 mol/L or more and 4 mol/L or less.

Furthermore, as described in Example 16, the comparison with Example 11 and Example 12 with the same concentration of the calcium hydroxide slurry indicates that installing the inline mixer can shorten the blowing time of the fine bubbles containing carbon dioxide. It is presumed that this is because suitable mixing of the microbubbles and the ultrafine bubbles generated from the fine bubble generation device and the slurry by the line mixer while the bubbles and the slurry pass the circulation line shortened the reacting time.

### 3. Third Test

In this test, a condition to manufacture calcium carbonate continuously without excessively increasing the pressure in the container was examined.

### Example 21

Calcium carbonate was manufactured continuously using a manufacturing apparatus for calcium carbonate as illustrated in FIG. 4. As the container, a reaction tank similar to that in the first test was used. In the reaction tank, a stirring blade of +9 cm was set. As the fine bubble generation device, an inline type ceramic fine bubble generation device (manufactured by NORITAKE CO., LIMITED, in which the fine bubble generation tube has an average pore diameter of 3.4 μm, an inner diameter of 3 mm, and a length (L) of 100 mm) as illustrated in FIG. 2 was used. To the reaction tank having the cylindrical columnar shape, 1.5 L of a calcium hydroxide slurry of 1 mol/L was prepared and input. The calcium hydroxide slurry before the reaction started had a pH of about 12.55 to 12.6 and a temperature of 20° C. to 22° C. Next, the suction pump was operated to circulate the slurry accumulated in the reaction tank. At this time, the flow rate X of the slurry circulating in the circulation line was controlled to be 1100 ml/min (the flow speed in the fine bubble generation tube was 2.6 m/s). Next, the carbon dioxide gas of 100%, the supply rate Y of which was controlled to be 540 ml/min, was supplied to the prepared fine bubble generation device, thereby blowing fine bubbles containing carbon dioxide into the slurry. Note that the supply pressure of carbon dioxide was controlled in the range of 0.035 MPa to 0.08 MPa so as to keep the difference in pressure from the inside of the container where the ultrafine bubbles were generated easily. Carbon dioxide was supplied continuously and when the carbonation rate became about 50%, the collection valve of the reaction tank was opened to extract the slurry containing calcium carbonate. At the same time, the calcium hydroxide slurry in the same amount as the amount of extracted slurry was supplied into the reaction tank by opening the valve of the slurry supply line. Thus, without releasing the carbon dioxide gas from the reaction tank, the slurry containing calcium carbonate with a carbonation rate of about 50% was able to be produced continuously.

In addition, the maximum pressure (MPa) in the container in the continuous production since the blowing of the fine bubbles containing carbon dioxide was started was measured. The results are shown in Table 3.

TABLE 3

| | | | | | | Supply | | | Maximum |
|---|---|---|---|---|---|---|---|---|---|
| | | | | Average pore | Flow rate X | rate Y of | | Flow | pressure in |
| | Stirring | Line | Concentration | diameter | of slurry | gas | | speed | container |
| | machine | mixer | (mol/L) | (μm) | (ml/min) | (ml/min) | Y/X | (m/s) | (MPa) |
| Example 21 | Present | Absent | 1 | 3.4 | 1100 | 540 | 0.49 | 2.6 | 0.05 |

As shown in Table 3, it was understood that even in the case of supplying carbon dioxide continuously, the maximum pressure in the container was able to be made 0.05 MPa or less. Thus, calcium carbonate can be manufactured continuously in the case of controlling the supply rate Y of the carbon dioxide gas and the flow rate X of the slurry so that the ratio (Y/X) of the supply rate Y of the carbon dioxide gas to the flow rate X of the slurry becomes 1 or less.

The device structure described in the above test examples does not limit the art disclosed herein. The manufacturing apparatus and the manufacturing method for calcium carbonate disclosed herein can be implemented by changing the scale or the like of the device structure as appropriate, for example.

The specific examples of the present invention have been described above in detail; however, these are just examples and will not limit the scope of claims. The art described in the scope of claims includes those in which the specific examples given above are variously modified and changed.

1. A manufacturing apparatus for calcium carbonate, comprising:
a reaction tank with airtightness not release carbon dioxide;
a slurry supplying means that is configured to supply a slurry containing calcium hydroxide into the reaction tank;
a fine bubble generation device that is configured to blows the carbon dioxide as fine bubbles into the slurry; and
a circulation line that includes a space in which the slurry can flow and can be formed through the reaction tank and the fine bubble generation device,
wherein:
the fine bubble generation device includes a fine bubble generation tube with a tubular shape that is formed of a porous body,
the fine bubble generation tube and the circulation line are connected to each other, and
the carbon dioxide can be blown as the fine bubbles into the slurry flowing in the fine bubble generation tube by supplying a carbon dioxide gas into the fine bubble generation device from outside.

2. The manufacturing apparatus according to claim 1, wherein the circulation line is configured to circulate the slurry from an upper part to a bottom part of the reaction tank.

3. The manufacturing apparatus according to claim 2, wherein the circulation line includes an inline mixer on a downstream side relative to the fine bubble generation device.

4. The manufacturing apparatus according to claim 1, wherein the reaction tank includes a stirring machine that can stir the slurry.

5. The manufacturing apparatus according to claim 1, further comprising a second circulation line that includes a space in which the supplied carbon dioxide can flow and that is formed through the reaction tank and a carbon dioxide gas supplying means that supplies the carbon dioxide gas to the fine bubble generation tube from the outside, wherein the second circulation line is configured to circulate the carbon dioxide from an upper part to a bottom part of the reaction tank.

6. A manufacturing method for calcium carbonate, comprising:
a step A of preparing a slurry containing calcium hydroxide;
a step B of supplying the slurry into a reaction tank with airtightness to not release carbon dioxide to an air;
a step C of circulating the slurry supplied into the reaction tank using a circulation line formed through the reaction tank and a fine bubble generation device; and
a step D of blowing carbon dioxide as fine bubbles into the slurry using the fine bubble generation device,
wherein:
the fine bubble generation device used in the step D includes a fine bubble generation tube with a tubular shape that is formed of a porous body,
the fine bubble generation tube and the circulation line are connected to each other, and,
in the step D, when a flow rate of the slurry circulating in the circulation line is a flow rate X (mL/min) and a supply rate of a carbon dioxide gas to the fine bubble generation device is a flow rate Y (mL/min), the carbon dioxide gas is supplied from outside to the fine bubble generation device so that a ratio (Y/X) of the supply rate Y of the carbon dioxide gas to the flow rate X of the slurry becomes 1 or less and the carbon dioxide is blown as the fine bubbles into the slurry flowing in the fine bubble generation tube.

7. The manufacturing method according to claim 6, wherein the ratio (Y/X) of the flow rate Y of the carbon dioxide to the flow rate X of the slurry is 0.16 or more and 1 or less.

8. The manufacturing method according to claim 6, wherein a concentration of the calcium hydroxide in the slurry containing the calcium hydroxide is 0.1 mol/L or more and 4 mol/L or less.

9. The manufacturing method according to claim 6, wherein in the step C, the slurry supplied to the reaction tank circulates from an upper part to a bottom part of the reaction tank.

10. The manufacturing method according to claim 6, wherein;
the fine bubbles have an average particle diameter of 100 μm or less, and
the fine bubbles include at least ultrafine bubbles with a particle diameter of less than 1 μm.

11. The manufacturing method according to claim 6, further comprising a step E of stirring the slurry in a downstream step relative to the step B.

12. The manufacturing method according to claim 6, further comprising a step F of extracting the supplied carbon dioxide and supplying the carbon dioxide again to the reaction tank through the fine bubble generation device in a downstream step relative to the step D, wherein the step F is performed by circulating the carbon dioxide using a second circulation line formed through the reaction tank and a carbon dioxide gas supplying means.
